(19) United States
(12) Patent Application Publication
(10) Pub. No.: US 2014/0324701 A1
(43) Pub. Date: Oct. 30, 2014

(54) METHOD FOR COMPLETING PAYMENT BY USING TWO MOBILE TERMINALS

(71) Applicant: Huawei Technologies Co., Ltd., Shenzhen (CN)

(72) Inventor: Heng JIANG, Shenzhen (CN)

(21) Appl. No.: 14/323,706

(22) Filed: Jul. 3, 2014

Related U.S. Application Data
(63) Continuation of application No. PCT/CN2012/084650, filed on Nov. 15, 2012.

(30) Foreign Application Priority Data
Mar. 21, 2012 (CN) 201210076527.3

(51) Int. Cl. G06Q 20/32; G06Q 20/42

(52) U.S. Cl. CPC G06Q 20/3223; G06Q 20/42
USPC 705/44

(57) ABSTRACT

The present invention relates to the field of communications, and in particular, to a mobile payment method. A payment method is provided, including: receiving a money receiving request that carries first payment information and is sent by a money receiving terminal; receiving a payment request indicating that a payment is agreed from a paying terminal, where the payment request carries second payment information; verifying whether the first payment information and the second payment information meet a transaction condition; and after the verification succeeds, transferring, according to the second payment information, money from an account corresponding to the paying terminal to an account corresponding to the money receiving terminal. A money receiving request and a payment request are initiated at a same time through two channels, thereby reducing delays caused by various transaction message notifications, simplifying a transaction procedure, and accelerating a transaction process.

### CROSS-REFERENCE TO RELATED APPLICATION

This application is a continuation of International Patent Application No. PCT/CN2012/084650, filed on Nov. 15, 2012, which claims priority to Chinese Patent Application No. 201210076527.3, filed on Mar. 21, 2012, both of which are hereby incorporated by reference in their entireties.

### TECHNICAL FIELD

The present invention relates to the field of communications, and in particular, to a mobile payment method.

### BACKGROUND

With development of Internet technologies and establishment of the UnionPay inter-bank transaction settlement system, a traditional manner of paying cash at a counter is more replaced by payment with bank cards and credit cards.

An SIM card of a mobile phone, as a mobile communications tool, is also developed as a payment means, for example: a SIM card can replace a public transportation card and function as a payment medium for taking a subway or a bus.

However, in the payment methods, reading is completed based on physical contact to further implement a payment; and for an online bank that supports a remote payment, a customer needs to log in to a website of a specified online bank, and only after completing complex verification operations can the customer implement a payment.

### SUMMARY

According to the disadvantages in the prior art, a method for implementing a payment process by means of mobile communication without physical contact is provided.

According to one aspect, an embodiment of the present invention provides a payment method, including:

receiving a money receiving request that carries first payment information and is sent by a money receiving terminal; receiving a payment request indicating that a payment is agreed from a paying terminal, where the payment request carries second payment information; and verifying whether the first payment information and the second payment information meet a transaction condition, and after the verification succeeds, transferring, according to the second payment information, money from an account corresponding to the paying terminal to an account corresponding to the money receiving terminal.

According to another aspect, a transfer platform is provided, including:

a first receiving apparatus, configured to receive a money receiving request that carries first payment information and is sent by a money receiving terminal; a second receiving apparatus, configured to receive a payment request indicating that a payment is agreed from a paying terminal, where the payment request carries second payment information; and a settlement apparatus, configured to verify whether the first payment information and the second payment information meet a transaction condition, and after the verification succeeds, further transfer, according to the second payment information, money from an account corresponding to the paying terminal to an account corresponding to the money receiving terminal.

In the present invention, a money receiving request and a payment request are initiated at a same time through two channels, thereby reducing delays caused by various transaction message notifications, simplifying a transaction procedure, and accelerating a transaction process.

### BRIEF DESCRIPTION OF DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic diagram of a payment method according to an embodiment of the present invention;

FIG. 2 is a schematic diagram of a method for completing a payment by using two mobile terminals according to an embodiment of the present invention;

FIG. 3 is a schematic structural diagram of a transfer platform according to an embodiment of the present invention; and

FIG. 4 is a schematic diagram of a transfer system according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

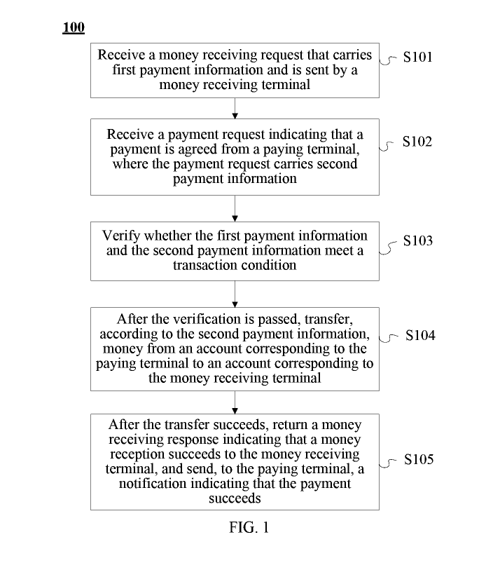

As shown in FIG. 1, a payment method 100 provided by the present invention includes:

S101. Receive a money receiving request that carries first payment information and is sent by a money receiving terminal.

The money receiving terminal may be a point of sale (POS) machine, an ordinary mobile phone, or a smart phone, and further, may also be a device with a data communication function, such as a PDA, a PC, or a tablet computer. The first payment information may include: a customer identifier, a merchant identifier, and a payment amount, and may further include one or more combination of a product list, a transaction time, and a transaction address. The customer identifier may be a mobile phone number, a bank account number, a payment account name, or the like of a customer, and the merchant identifier may be a shop name of a merchant, an identifier of a POS machine of the merchant, or a payment account number of the merchant. When customized information such as the shop name of the merchant is used, a transfer platform further needs to perform an operation of converting the shop name of the merchant into an account of the merchant.

For example: a merchant may enter a mobile phone number of a customer by using the POS machine, and send, to the transfer platform, a money receiving request that carries the mobile phone number of the customer, a payment amount, and a merchant identifier.

S102. Receive a payment request indicating that a payment is agreed from a paying terminal, where the payment request carries second payment information.

The paying terminal may be a device with a data communication function, such as a mobile phone, a tablet computer, or a PDA. The second payment information preferably includes: a customer identifier, a merchant identifier, and a payment amount.

Preferably, the second payment information further carries a customer password, where the password is used for the transfer platform to verify permission of a customer over an account corresponding to the paying terminal.

Optionally, the account corresponding to the paying terminal may also be obtained in a binding manner by verifying the customer identifier.

Optionally, the paying terminal may send the payment request in an interactive voice response (IVR) manner, an unstructured supplementary services data (USSD) manner, a subscriber identity module application tool kit (STK) manner, or a wireless application protocol (WAP) manner. A short message manner may also be adopted. Preferably, when the payment request is sent by using a short message, the paying terminal first encrypts the second payment information, and corresponding decryption is performed at a transfer platform.

S103. Verify whether the first payment information and the second payment information meet a transaction condition.

Preferably, the first payment information and the second payment information each include a customer identifier, a payment amount, and a merchant identifier. The transfer platform verifies that the customer identifier, the merchant identifier, and the payment amount that are carried by the first payment information are respectively the same as the customer identifier, the merchant identifier, and the payment amount that are carried by the second payment information, and a result indicates that the verification succeeds.

Optionally, the first payment information and the second payment information each carry a key word, where the key word is temporarily specified by a customer and a merchant during a transaction, and may be a specific noun or a certain string of digits, for example: “TianLe”, or “13254”. Before verifying whether the first payment information and the second payment information meet the transaction condition, the transfer platform determines that the key word in the first payment information and the key word in the second payment information are the same, and when the key words are the same, the transfer platform performs a process of the verification. If no same key word is matched, it indicates that the transfer platform does not receive, after receiving the payment request, any money receiving request corresponding to the payment request, or does not receive, after receiving the money receiving request, any payment request corresponding to the money receiving request.

Introduction of a key word can ensures that a customer can complete multiple times of transactions with a same merchant within a short period of time, and a situation can be avoided, in which a transaction failure is caused because the transfer platform receives a money receiving request and a payment request that involve different amounts and are sent by a same pair of customer and merchant. Specifically, a money receiving request of an earlier transaction and a payment request of a later transaction are verified first due to a network delay, and because the amount of the earlier transaction is different from the amount of the later transaction, the verification leads to the transaction failure because the amounts are verified to be different.

Optionally, when the first payment information carries a first sending time of the money receiving request, and the second payment information carries a second sending time of the payment request, it is compared that a corresponding time interval between the first sending time and the second sending time is within a specified threshold; if a corresponding time interval is beyond a specified threshold, the verification fails.

S104. After the verification succeeds, transfer, according to the second payment information, money from an account corresponding to the paying terminal to an account corresponding to the money receiving terminal.

Optionally, the first payment information further includes a product list, a transaction address, and a transaction time. After completing the transfer, the transfer platform stores the product list, the transaction address, the payment amount, the merchant identifier, and the transaction time that are corresponding to the customer identifier. Further, the customer may search for a history of the foregoing transaction by using a short message or in a manner of using IVR, USSD, or the like.

S105. After the transfer succeeds, return, to the money receiving terminal, a money receiving response indicating that a money reception succeeds, and send, to the paying terminal, a notification indicating that the payment succeeds.

Preferably, when the payment request returned by the paying terminal exceeds a transaction time limit, a failure message indicating that the transaction cannot be completed due to a timeout is returned to the money receiving terminal and the paying terminal.

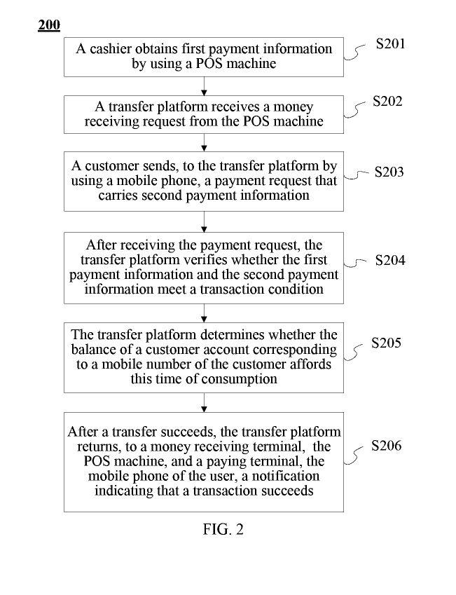

As shown in FIG. 2, the present invention provides a method 200 of completing a payment by using two mobile terminals. The two mobile terminals are corresponding to a money receiving terminal and a paying terminal. An account corresponding to the money receiving terminal and an account corresponding to the paying terminal are specifically represented as an account of a merchant on a transfer platform and an account of a customer on the transfer platform, and a payment process is complete by using the transfer platform. The two mobile terminals may be a POS machine and a mobile phone, or may be two mobile phones, or may be another combination of a POS machine, a mobile phone, a tablet computer, and a PDA, except the foregoing existing combinations. A customer identifier may be a mobile phone number, an IMS account number, or a customized account number of a customer. In this embodiment, a mobile phone number of a customer is used as a customer identifier, and a merchant identifier is specifically represented as a merchant ID. In this embodiment, the account corresponding to the money receiving terminal is represented as the account of the merchant, and the account corresponding to the paying terminal is represented as the account of the customer. After selecting a product, the customer completes a payment by using a cash register, of which a specific process is as follows:

S201. A cashier obtains first payment information by using a POS machine, where the first payment information includes a transaction ID, a merchant ID, a list of purchased products, a key word, and a total payment amount. Further, the cashier enters a mobile phone number of a purchaser, a customer A, by using the POS machine, and sends, to the transfer platform, a money receiving request that carries a mobile phone number of the customer, the merchant ID, the transaction ID, a list of products, the key word, and the total payment amount.

S202. After receiving the money receiving request from the POS machine, the transfer platform determines an account of a merchant that is bound to the POS machine; and further extracts the mobile phone number of the customer A from the money receiving request, and searches its own system for a customer account that is bound to the mobile phone number of the customer. If the customer account is not found, an error prompt message indicating that no corresponding customer account exists is returned to the POS machine. The customer account may be a bank account, or may be an account on a third-party payment platform, where the third-party payment platform includes various major communications carriers.

Preferably, a pre-transaction association table is maintained on the transfer platform. Both the first payment information in the money receiving request and second payment information in a payment request carry a customer identifier and a merchant identifier that are used to complete this request. Therefore, no matter the money receiving request or the payment request is received first, an association relationship between the customer identifier and the merchant identifier can be established in the pre-transaction association table, so that when a corresponding money receiving request or payment request is received, both the transaction parties can be found faster to complete a transaction process. If the transfer platform fails to find, from the association table, any customer identifier corresponding to the merchant identifier, the transfer platform adds the merchant identifier and a corresponding customer identifier to the pre-transaction association table.

S203. The customer seds, to the transfer platform by using a mobile phone, the payment request that carries the second payment information. The second payment information includes a merchant ID, a mobile phone number, a key word, and a total payment amount. Specifically, the customer knows the merchant ID and the total payment amount from the merchant, and further enters the second payment information by using an application of the transform platform on the mobile phone, and sends the payment request to the transfer platform through a channel established in an STK manner.

Optionally, the payment request may be a short message or USSD, or in a manner of an IVR, so as to achieve a purpose of notifying the transfer platform of performing a transaction.

S204. After receiving the payment request, the transfer platform verifies whether the first payment information and the second payment information meet a transaction condition. Specifically, the transfer platform first matches the key word in the first payment information with the key word in the second payment information, and when the key words are the same, further performs a verification process to verify that the customer identifier, the merchant identifier, and the payment amount that are carried by the first payment information are respectively the same as the customer identifier, the merchant identifier, and the payment amount carried in the second payment information, which indicates that the verification succeeds.

After receiving the payment request, the transfer platform obtains the customer identifier and the merchant identifier that are included in the payment request, and searches the pre-transaction association table for records of the two identifiers.

Preferably, when the money receiving request or the payment request is added, the pre-transaction association table records a first sending time carried in the corresponding money receiving request and a second sending time carried in the corresponding payment request, and compares that a corresponding time interval between the first sending time and the second sending time is within a specified threshold; if a corresponding time interval is beyond a specified threshold, the verification fails. The pre-transaction association table may be specifically represented as follows:

| | Merchant | | | |
|---|---|---|---|---|
| Customer | identifier/ | First | Second | Total |
| identifier/Received | Received | sending | sending | payment |
| (bool) | (bool) | time | time | amount |
| 18663908904/false | Lihong/true | 2012-3-20 | | 300 |
| | | 9:39 | | |

The relationship between true and false in the table indicates that the transfer platform receives a money receiving request of the POS machine first, records, in the pre-transaction association table, an association relationship between the money receiving request and the customer identifier, and marks a state of the corresponding customer identifier as false to indicate that no corresponding payment request is received. Optionally, if the first payment information or the second payment information is first received, a total payment amount and a key word therein are stored in the pre-transaction association table, so as to facilitate the verification process subsequently.

S205. The transfer platform determines whether the balance of the customer account corresponding to the mobile phone number of the customer affords this time of consumption. The verification process may further include whether this time of consumption exceeds a single transaction limit, whether this time of consumption exceeds a limit of a maximum daily accumulative transactions, or the like. When the verification result indicates that the balance is enough, the transfer platform transfers, according to the second payment information, money from the account corresponding to the paying terminal to the account corresponding to the money receiving terminal.

When verifying that the balance of the customer account is not enough to complete this transaction, the transfer platform returns a prompt message indicating that the transaction fails to the POS machine of the cashier. Optionally, the message carries an error cause “The balance of the customer is not enough”.

S206. After the transfer succeeds, the transfer platform returns, to the money receiving terminal, the POS machine, a money receiving response indicating that a money reception succeeds, and sends, to the paying terminal, the mobile phone of the customer, a notification indicating that the payment succeeds.

In this embodiment, in consideration of execution efficiency of the transfer platform, the transfer platform preferably selects to determine the balance of a payment account after a payment request is received. The determining of the balance of the payment account may also be performed after the money receiving request sent by the POS machine of the merchant is received.

In this embodiment, two mobile terminals send in parallel a money receiving request and a payment request respectively within a specified time, and first payment information and second payment information that are carried therein are verified to meet a transaction condition, and a transfer is further completed. Compared with the prior art, the number of transaction messages and the number of times a transaction message is transmitted on the network are reduced, and objectives of reducing network channel traffic and a wait time that is required by serial transactions are achieved.

In this embodiment, description is provided using a customer and a merchant as transaction parties. Real transaction may also be between customers or between merchants, which are not limited herein.

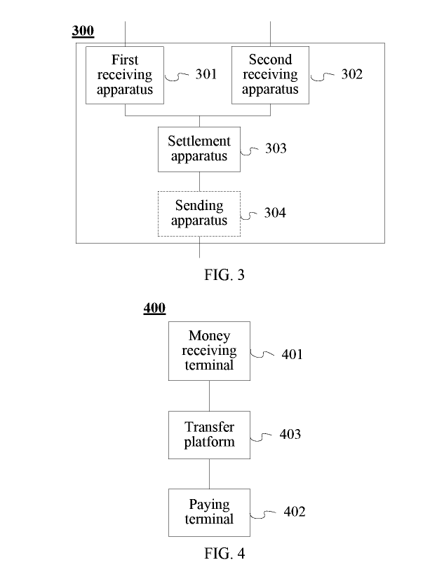

As shown in FIG. 3, a transfer platform 300 provided by the present invention includes:

a first receiving apparatus 301, configured to receive a money receiving request that carries first payment information and is sent by a money receiving terminal;

a second receiving apparatus 302, configured to receive a payment request indicating that a payment is agreed from a paying terminal, where the payment request carries second payment information; and

a settlement apparatus 303, configured to verify whether the first payment information and the second payment information meet a transaction condition, and after the verification succeeds, further transfer, according to the second payment information, money from an account corresponding to the paying terminal to an account corresponding to the money receiving terminal.

Preferably, the transfer platform further includes:

a sending apparatus 304, configured to return, to the money receiving terminal, a money receiving response indicating that a money reception succeeds, and send, to the paying terminal, a notification indicating that the payment succeeds.

Preferably, the settlement apparatus 303 verifies that the customer identifier, the merchant identifier, and the payment amount that are carried by the first payment information are respectively the same as the customer identifier, the merchant identifier, and the payment amount that are carried by the second payment information, which indicates that the verification succeeds.

Preferably, when the first payment information and the second payment information each carry a key word, the settlement apparatus is further configured to match the key word in the first payment information with the key word in the second payment information, and when a matching result indicates that the key words are the same, further perform the process of verifying whether the first payment information and the second payment information meet a transaction condition.

Optionally, when the first payment information carries a first sending time of the money receiving request, and the second payment information carries a second sending time of the payment request, the settlement apparatus 303 is further configured to compare that a corresponding time interval between the first sending time and the second sending time is within a specified threshold; if a corresponding time interval is beyond a specified threshold, the verification fails.

As shown in FIG. 4, a transfer system 400 provided by the present invention includes:

a money receiving terminal 401 is configured to send a money receiving request that carries first payment information to a transfer platform;

a paying terminal 402 is configured to send, to the transfer platform, a payment request indicating that a payment is agreed, where the payment request carries second payment information; and

the transfer platform 403 is configured to receive the money receiving request that carries the first payment information and is sent by the money receiving terminal; receive, from the paying terminal, the payment request indicating that the payment is agreed, where the payment request carries the second payment information; and verify whether the first payment information and the second payment information meet a transaction condition, and after the verification succeeds, further transfer, according to the second payment information, money from an account corresponding to the paying terminal to an account corresponding to the money receiving terminal.

Preferably, the first payment information and the second payment information each include a customer identifier, a payment amount, and a merchant identifier, the transfer platform 403 verifies that the customer identifier, the merchant identifier, and the payment amount that are carried by the first payment information are respectively the same as the customer identifier, the merchant identifier, and the payment amount that are carried by the second payment information, which indicates that the verification succeeds.

Optionally, the first payment information and the second payment information each further carry a key word, and the transfer platform 403 determines, before verifying that the first payment information and the second payment information meet the transaction condition, that the key word in the first payment information is the same with the key word in the second payment information.

Optionally, when the first payment information further carries a first sending time of the money receiving request, the second payment information further carries a second sending time of the payment request, the transfer platform 403 compares that a corresponding time interval between the first sending time and the second sending time is within a specified threshold; if a corresponding time interval is beyond a specified threshold, the verification fails.

Preferably, the transfer platform 403 is further configured to return, to the money receiving terminal, a money receiving response indicating that a money reception succeeds, and send, to the paying terminal, a notification indicating that the payment succeeds.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of the present invention.

The steps of methods described in the embodiments disclosed in this specification may be implemented by hardware, a software program executed by a processor, or a combination thereof. The software program may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The present invention is described in detail with reference to the accompany drawings in combination with the exemplary embodiments, but the present invention is not limited thereto. Various equivalent modifications or replacements may be made to the embodiments of the present invention by a person of ordinary skill in the art without departing from the spirit and essence of the present invention, and such modifications or replacements shall fall within the scope of the present invention.

What is claimed is:

1. A payment method, comprising:
receiving a money receiving request that carries first payment information and is sent by a money receiving terminal;
receiving a payment request indicating that a payment is agreed from a paying terminal, wherein the payment request carries second payment information;
verifying whether the first payment information and the second payment information meet a transaction condition; and
after the verification succeeds, transferring, according to the second payment information, money from an account corresponding to the paying terminal to an account corresponding to the money receiving terminal.

2. The method according to claim 1, wherein the first payment information and the second payment information each comprise a customer identifier, a payment amount, and a merchant identifier, and the verifying whether the first payment information and the second payment information meet a transaction condition specifically comprises:
determining that the customer identifier, the merchant identifier, and the payment amount that are carried by the first payment information are respectively the same as the customer identifier, the merchant identifier, and the payment amount that are carried by the second payment information, which indicates that the verification succeeds.

3. The method according to claim 2, wherein the first payment information and the second payment information each further carry a key word, and before the verifying whether the first payment information and the second payment information meet a transaction condition, the method further comprises:
determining that the key word in the first payment information and the key word in the second payment information are the same.

4. The method according to claim 2, wherein the first payment information further carries a first sending time of the money receiving request, and the second payment information further carries a second sending time of the payment request, and the verifying whether the first payment information and the second payment information meet a transaction condition further comprises:
determining that a corresponding time interval between the first sending time and the second sending time is within a specified threshold.

5. The method according to claim 2, wherein the first payment information further comprises a product list, a transaction address, and a transaction time, and after the transferring, according to the second payment information, money from an account corresponding to the paying terminal to an account corresponding to the money receiving terminal, the method further comprises:
storing the product list, the transaction address, and the transaction time according to the customer identifier.

6. The method according to claim 1, wherein the method further comprises:
after the transfer succeeds, returning, to the money receiving terminal, a money receiving response indicating that a money reception succeeds, and sending, to the paying terminal, a notification indicating that the payment succeeds.

7. The method according to claim 2, wherein the method further comprises:
after the transfer succeeds, returning, to the money receiving terminal, a money receiving response indicating that a money reception succeeds, and sending, to the paying terminal, a notification indicating that the payment succeeds.

8. The method according to claim 1, wherein a manner used for the receiving a payment request indicating that a payment is agreed from a paying terminal comprises:
an interactive voice response IVR manner, an unstructured supplementary services data USSD manner, a subscriber identity module application tool kit STK manner, or a wireless application protocol WAP manner.

9. A transfer platform, comprising:
a first receiving apparatus, configured to receive a money receiving request that carries first payment information and is sent by a money receiving terminal;
a second receiving apparatus, configured to receive a payment request indicating that a payment is agreed from a paying terminal, wherein the payment request carries second payment information; and
a settlement apparatus, configured to verify whether the first payment information and the second payment information meet a transaction condition, and after the verification succeeds, transfer, according to the second payment information, money from an account corresponding to the paying terminal to an account corresponding to the money receiving terminal.

10. The platform according to claim 9, wherein the first payment information and the second payment information each comprise a customer identifier, a payment amount, and a merchant identifier, the verification by the settlement apparatus specifically comprises:
verifying, by the settlement apparatus, that the customer identifier, the merchant identifier, and the payment amount that are carried by the first payment information are respectively the same as the customer identifier, the merchant identifier, and the payment amount that are carried by the second payment information, which indicates that the verification succeeds.

11. The platform according to claim 10, wherein the first payment information and the second payment information each further carry a key word, and the settlement apparatus is further configured to:
before verifying that the first payment information and the second payment information meet the transaction condition, determine that the key word in the first payment information and the key word in the second payment information are the same.

12. The platform according to claim 10, wherein the first payment information further carries a first sending time of the money receiving request, and the second payment information further carries a second sending time of the payment request, and the settlement apparatus is further configured to:
compare that a corresponding time interval between the first sending time and the second sending time is within a specified threshold; otherwise, the verification fails.

13. The platform according to claim 9, wherein the apparatus further comprises:
a sending apparatus, configured to return, to the money receiving terminal, a money receiving response indicating that a money reception succeeds, and send, to the paying terminal, a notification indicating that the payment succeeds.

14. The platform according to claim 10, wherein the apparatus further comprises:
a sending apparatus, configured to return, to the money receiving terminal, a money receiving response indicating that a money reception succeeds, and send, to the paying terminal, a notification indicating that the payment succeeds.

15. A transfer system, comprising:
a money receiving terminal, configured to send a money receiving request that carries first payment information to a transfer platform;
a paying terminal, configured to send, to the transfer platform, a payment request indicating that a payment is agreed, wherein the payment request carries second payment information; and
the transfer platform, configured to receive the money receiving request that carries the first payment information and is sent by the money receiving terminal; receive, from the paying terminal, the payment request indicating that the payment is agreed, wherein the payment request carries the second payment information; and verify whether the first payment information and the second payment information meet a transaction condition, and after the verification succeeds, transfer, according to the second payment information, money from an account corresponding to the paying terminal to an account corresponding to the money receiving terminal.

16. The system according to claim 15, wherein the first payment information and the second payment information each comprise a customer identifier, a payment amount, and a merchant identifier, the verification by the transfer platform specifically comprises:
verifying, by the transfer platform, that the customer identifier, the merchant identifier, and the payment amount that are carried by the first payment information are respectively the same as the customer identifier, the merchant identifier, and the payment amount that are carried by the second payment information, which indicates that the verification succeeds.

17. The system according to claim 16, wherein the first payment information and the second payment information each further carry a key word, and the transfer platform is further configured to:
before verifying that the first payment information and the second payment information meet the transaction condition, determine that the key word in the first payment information and the key word in the second payment information are the same.

18. The system according to claim 16, wherein the first payment information further carries a first sending time of the money receiving request, and the second payment information further carries a second sending time of the payment request, and the transfer platform is further configured to:
determining that a corresponding time interval between the first sending time and the second sending time is within a specified threshold.

19. The system according to claim 15, wherein the transfer platform is further configured to:
return, to the money receiving terminal, a money receiving response indicating that a money reception succeeds, and send, to the paying terminal, a notification indicating that the payment succeeds.

20. The system according to claim 16, wherein the transfer platform is further configured to:
return, to the money receiving terminal, a money receiving response indicating that a money reception succeeds, and send, to the paying terminal, a notification indicating that the payment succeeds.
